(19) United States
(12) Patent Application Publication
(10) Pub. No.: US 2001/0049312 A1
(43) Pub. Date: Dec. 6, 2001

(54) Variable speed drive system

(76) Inventors: Steven E. Warner, Kent, OH (US); Gary M. Putnam, Garrettsville, OH (US)

Correspondence Address: CALFEE HALTER & GRISWOLD, LLP, 800 SUPERIOR AVENUE, SUITE 1400, CLEVELAND, OH, 44114, US

(21) Appl. No.: 09/752,136

(22) Filed: Dec. 27, 2000

Related U.S. Application Data
(60) Provisional application No. 60/173,196, filed on Dec. 27, 1999.

(51) Int. Cl. F16H 59/00; F16H 7/08; F16H 63/00

(52) U.S. Cl. 474/18; 474/28; 474/101

(57) ABSTRACT

A variable speed drive system is provided for use in driving accessories. The system is driven by a rotational member, which can be a component of an engine or any other rotating device. The system includes two pulleys rotationally connected by a first belt. In order to change the speed of the second pulley the pitch radius of the first pulley can be varied by an actuating system which can be located remotely from the pulleys. The second pulley maintains tension within the first belt and drives accessories via a second belt. The system has infinitely variable speed control between minimum and maximum pitch ratios.

### PRIORITY CLAIM

This application claims the benefit of U.S. provisional patent application No. 60/173,196 filed on Dec. 27, 1999, the entirety of which is hereby incorporated by reference.

### FIELD OF THE INVENTION

This invention relates generally to engine driven accessories and more specifically to a system utilizing a variable speed drive to drive associated engine accessories to achieve one or more of the following: maximize fuel efficiency, reduce wear, reduce accessory size, weight and cost, or to reduce any other cost associated with the engine driven accessories.

### BACKGROUND OF THE INVENTION

Accessories are often part of engine-driven vehicles and stationary systems. The accessories are commonly driven and powered by the engine. The accessories can include alternators, generators, power steering pumps, air conditioners, water pumps, cooling fans, or air pumps. The accessories are linked to the engine typically through a continuous, or serpentine belt. Driving the accessories requires significant engine power. As an example, accessories on a vehicle equipped with a V-8 engine may require thirty or more horsepower. At low engine operating speeds, such as at idle speeds, this drain on the engine is most noticeable. An engine must be driven at a relatively higher idle speed to ensure the accessories are properly functioning at low engine speeds. Significant fuel savings can be realized by driving the accessories at a higher speed than the engine speed and reducing the engine idle speed. In addition, further fuel savings and manufacturer cost savings can be realized by making the accessories smaller and lighter. If the accessories are driven at a higher speed than engine speed at low engine speeds, any or all of the accessories can be made smaller and lighter and still function properly. Similarly, if the accessories are driven at a lower speed than engine speed at high engine speeds, the accessories can be made smaller and lighter while remaining functional.

Variable speed pulley systems are described in U.S. Pat. No. 4,573,948 ('948 patent) to Thirion de Briel and in U.S. Pat. No. 5,700,212 ('212 patent) to Meckstroth. These variable speed drive systems typically include an actuating variable speed drive pulley and a corresponding auto-tensioning pulley. The '948 patent utilizes a diaphragm system to actuate a movable flange within the pulley system to achieve the variable speed drive. That diaphragm system, however, does not provide a linear force like a piston system. The '212 patent utilizes a chain driven two speed system. This system does not provide an infinite number of speed variations for its drive pulley.

For the foregoing reasons, there is a need for an infinitely-variable, variable speed drive system for engines, vehicles, or any rotating member, such as a system directly or indirectly driven by an engine that can be quickly, easily, and precisely actuated within the vehicle or stationary system. The desired system needs to be functional and efficient at all operating speeds. The desired system also needs to generate forces to move flange faces which are highly responsive to system requirements.

### SUMMARY OF THE INVENTION

The present invention is directed to a variable speed drive system which is highly responsive to system requirements, which is infinitely variable, and which can operate at speeds independent of the speed of the device powering the system.

The present invention is directed to a variable speed drive system for driving accessories comprising a rotational member, a controllable pulley in rotational communication with the rotational member, the controllable pulley including a first movable flange and a corresponding adjustable pitch radius. The system also includes an auto-tensioning pulley driven by the controllable pulley via a first belt where the auto-tensioning pulley maintains tension in the first belt. The auto tensioning pulley has an operating speed which is infinitely variable between a minimum pitch ratio and a maximum pitch ratio. The system also includes an actuating system for moving the first movable flange, and one or more accessories which are driven by the auto-tensioning pulley via a second belt.

The present invention is also directed to a variable speed drive system for driving engine accessories comprising an engine, a first controllable pulley in rotational communication with the engine, the first controllable pulley including a first movable flange and a corresponding adjustable pitch radius. The system also includes a second controllable pulley driven by the first controllable pulley via a first belt, the second controllable pulley has a second movable flange, and an operating speed which is infinitely variable between a minimum pitch ratio and a maximum pitch ratio. The system also includes an actuating system for moving the first movable flange and a belt driving sheave attached to the second controllable pulley which drives one or more accessories via a second belt.

The present invention is also directed to a vehicle having an engine and a first controllable pulley in rotational communication with the engine. The first controllable pulley includes a first movable flange and a corresponding adjustable pitch radius. The system also includes an actuating system for moving the first movable flange, one or more accessories which are driven by a second belt, and rotating means that are rotatably connected to the first and second belts. The rotating means have an operating speed which is infinitely variable between a minimum pitch ratio and a maximum pitch ratio.

Between maximum over-drive and under-drive conditions, which are defined by the maximum and minimum pitch radii of the controllable pulley and auto-tensioning pulley, the variable speed drive system is infinitely variable. The variability of the system does not rely upon a maximum or minimum rotational speed of either the controllable pulley or auto-tensioning pulley. Any pitch ratio physically achievable by the sizes of the pulleys can be achieved at any rotational speed of the pulleys.

Actuation of the controllable pulley may be achieved by a system which is integral with the controllable pulley or which is remote from the controllable pulley. These and other features, aspects and advantages of the present invention will be fully described by the following description, appended claims, and accompanying drawings.

### BRIEF DESCRIPTION OF THE FIGURES

FIG. 1 is a schematic view of the variable speed drive system showing sectional views of the controllable and auto-tensioning pulleys;

FIG. 2 is a schematic view of the controllable and auto-tensioning pulleys and various accessories;

FIG. 3 is a sectional view of an embodiment of the invention using a counterweight system;

FIG. 4 is a sectional view of an embodiment of the invention using a non-rotating chamber system;

FIG. 5 is a sectional view of an embodiment of the invention using a second embodiment of the non-rotating chamber system;

FIG. 6 is a sectional view of an embodiment of the invention using a non-rotating chamber located adjacent to the mounting point of the controllable pulley;

FIG. 7A is a sectional view of an embodiment of the invention using a hydraulic or pneumatic cylinder to move a contact flange;

FIG. 7B is a sectional view of a second embodiment of the invention using a hydraulic or pneumatic cylinder to move a contact flange;

FIG. 7C is a sectional view of a third embodiment of the invention using a hydraulic or pneumatic cylinder to move a contact flange;

FIG. 8 is a sectional view of an embodiment of the invention using an electromechanical linear actuation device to move a contact flange;

FIG. 9 is a sectional view of an embodiment of the invention using a thermally responsive material to move a contact flange;

FIG. 10 is a sectional view of an embodiment of the invention using a magnetic actuation device to move a contact flange;

FIG. 11 is a sectional view of an embodiment of the invention using a pulley with two movable contact flanges;

FIG. 12 is a sectional view of an embodiment of the invention using a pulley with two hydraulically movable contact flanges;

FIG. 13 is a sectional view of an embodiment of the invention using two controllable pulleys;

FIG. 14 is a sectional view of an embodiment of the invention using a spring venting system; and

FIG. 15 is a is a schematic view of an the variable speed drive system showing sectional views of an embodiment of the controllable and auto-tensioning pulleys.

### DETAILED DESCRIPTION OF THE INVENTION

I. Variable Speed Drive—Structural

A. Basic

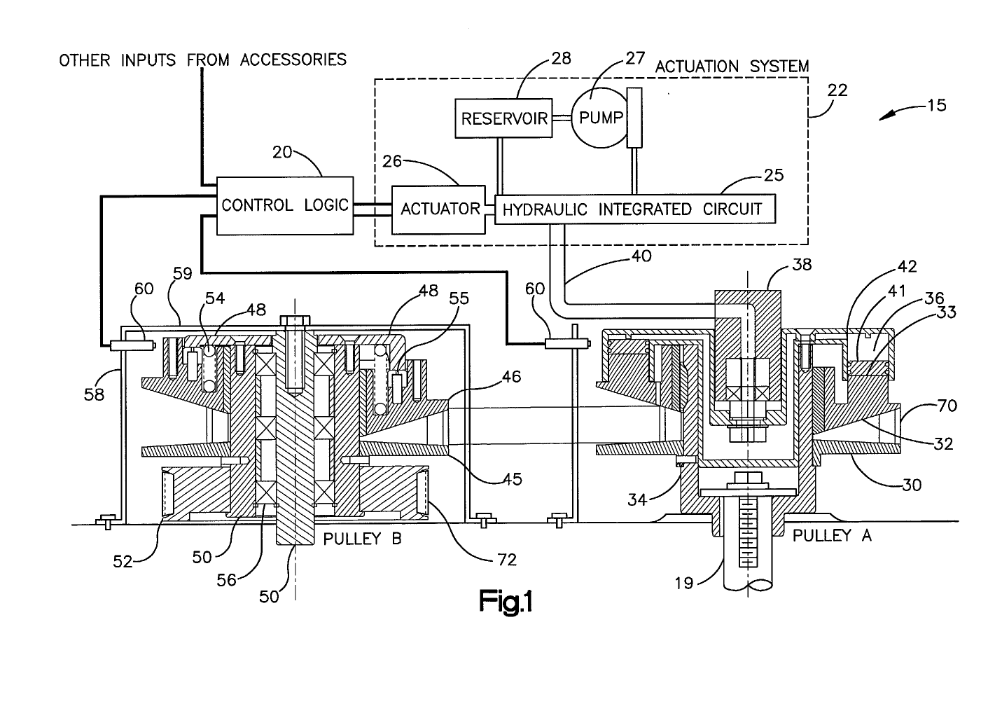

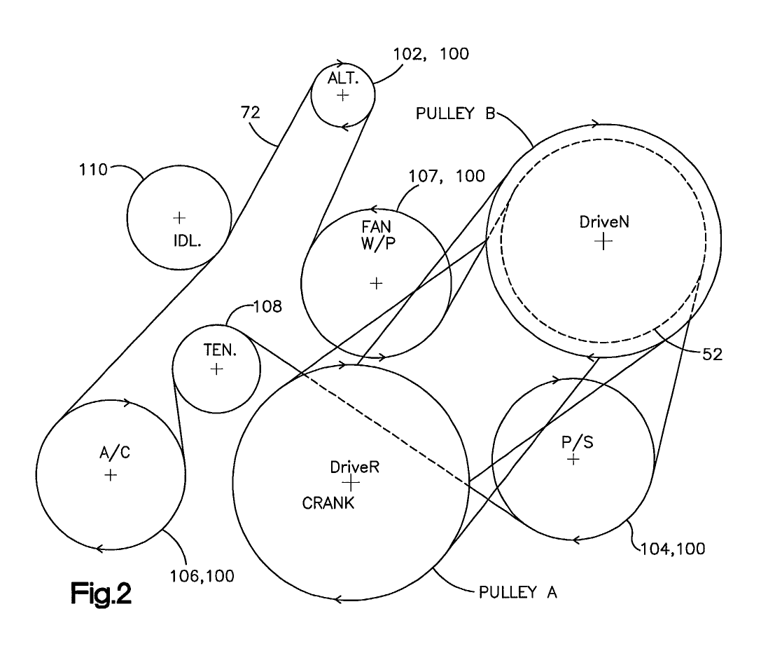

Referring now to the drawings wherein the figures are for purposes of illustrating preferred embodiments of the invention only and not for purposes of limiting same, FIG. 1 illustrates a variable speed drive system 15 of the present invention. The variable speed drive system 15 can be part of a vehicle. As illustrated, the invention includes a controllable pulley A and a companion, auto-tensioning pulley B linked with a belt 70. Controllable pulley A is in rotational communication with a rotational member 19. Rotational member 19 can be an engine component such as a crank, crankshaft, or camshaft, any member driven by an engine such as a driveshaft, axle, etc., or any rotating member, such as a wheel or an axel on a vehicle or a towed trailer. Controllable pulley A operates on variable pitch radii to vary the output speed of auto-tensioning pulley B in order to obtain a desired speed for driven accessories. Referring to FIG. 1, an overview of the drive system 15 contains the controllable pulley A, the auto-tensioning pulley B and the belt 70. As illustrated in the exemplary embodiment, the drive system 15 also includes one or more sensors 60, a control logic module 20, and an actuating system 22. In this embodiment actuating system 22 includes an actuator 26, a hydraulic integrated circuit 25, a hydraulic pump 27, a piston 41, and a hydraulic fluid reservoir 28. The drive system 15 also includes a continuous drive belt sheave 52 used to drive one or more accessories 100 as shown in FIG. 2.

B. Components—Controllable Pulley

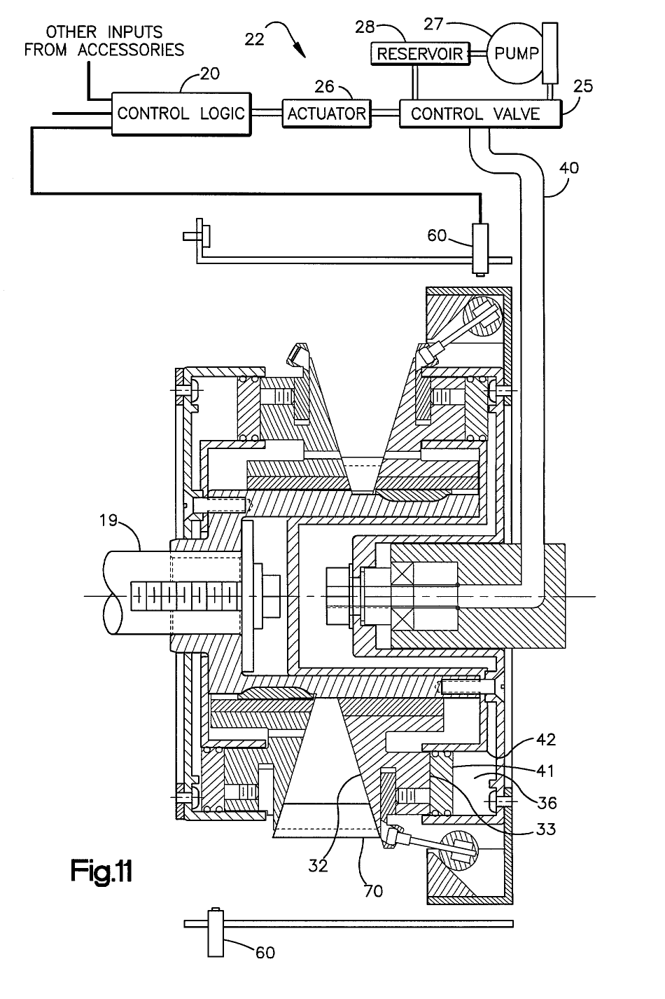

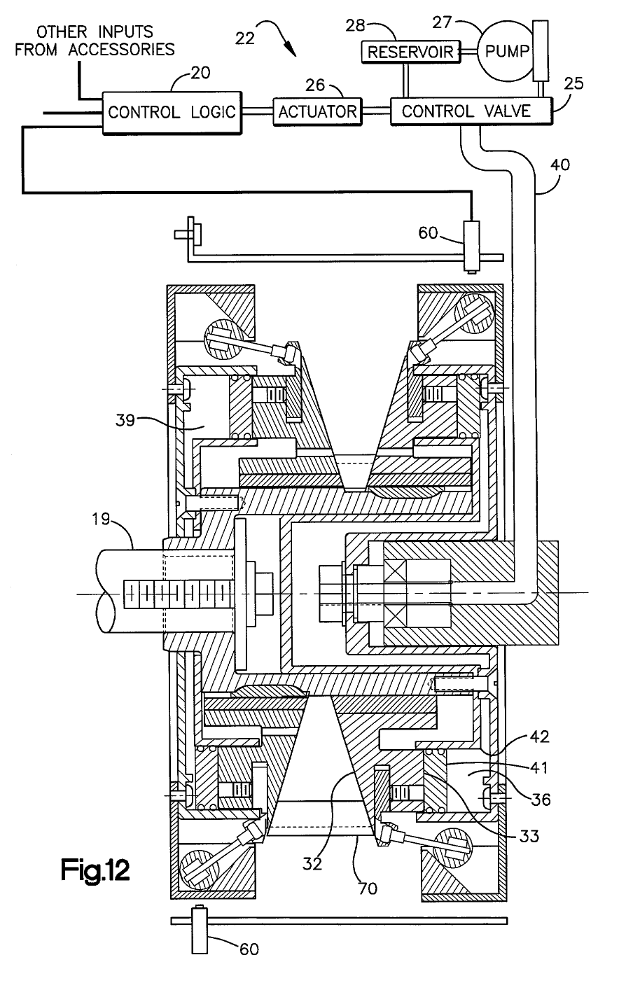

Referring to FIG. 1, controllable pulley A comprises two contact flanges 30 and 32 and a mounting shaft 34. In an embodiment, the first contact flange 30 is stationary and the second contact flange 32 movable. In another embodiment, shown in FIGS. 11 and 12, both contact flanges 30 and 32 are movable. Referring back to FIG. 1, the flanges 30 and 32 function to contact and support a belt 70 which transfers rotational motion from controllable pulley A to the other pulleys in the system. The position of belt 70 between the first contact flange 30 and second contact flange 32 defines the pitch radius of controllable pulley A.

In the illustrated embodiment, controllable pulley A includes a piston 41 and piston housing 42. The piston 41 abuts the rear face 33 of the second contact flange 32. The piston housing 42 is integral with controllable pulley A and holds the piston 41. The piston 41 functions to move the second contact flange 32. The piston 41 can be considered a linear actuating member because it provides a linear force to the second contact flange 32. The force is in-line and parallel with the direction of the movement of the contact flange 32. In alternate embodiments, linear actuating members include hydraulic cylinders and members attached thereto, magnetic actuators, and caps over thermally responsive material. Because a linear force is all that is required to move the second contact flange 32, the piston 41 or any linear actuating member is an energy efficient way to effect such movement. In an embodiment where the controllable pulley A is actuated by a hydraulic actuating system 22, controllable pulley A includes a hydraulic chamber 36 behind the piston 41. The hydraulic chamber 36 can be partially enclosed by the piston housing 42. The hydraulic chamber 36 can be filled with hydraulic fluid at times when the second contact flange 32 is being moved. In embodiments without hydraulic actuating systems, which will be more fully explained infra, the area behind the piston 41 can be eliminated or left open to hold a volume of thermally responsive material, one or more magnets, and other elements needed to make the non-hydraulic actuators work. As shown in FIG. 12, in an embodiment where both contact flanges are movable, controllable pulley A may include two hydraulic chambers 36 and 39. Alternatively, a linkage, such as a rack and pinion gear system may be placed between the contact flanges 30 and 32, to allow one flange to move in an equal and opposite direction when the alternate flange is actuated.

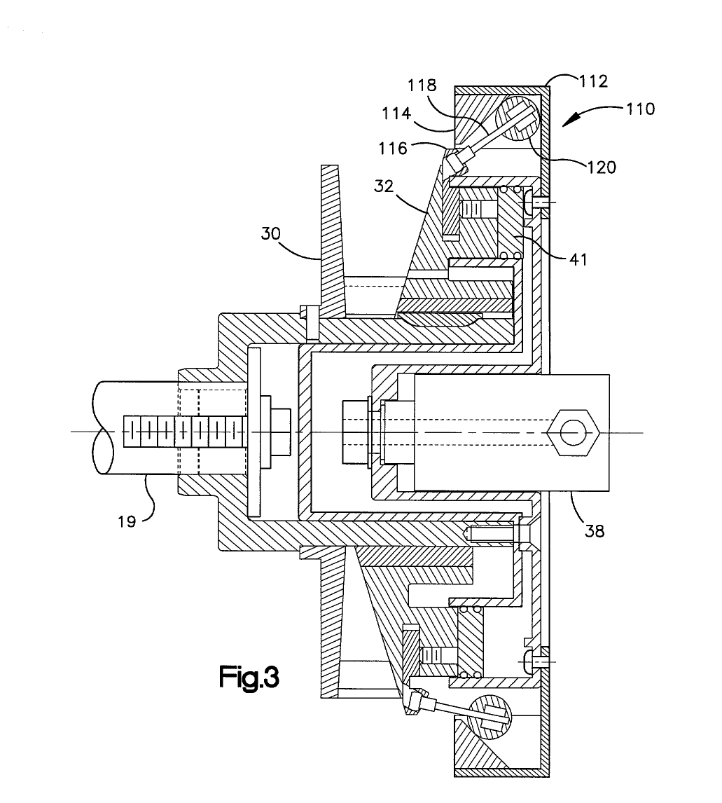

Referring to FIGS. 1 and 3, a rotary union 38 acts as a junction between controllable pulley A which rotates and stationary means for transferring “instructions” from the actuating system 22. In an embodiment where the actuating system 22 is hydraulic, the rotary union 38 carries hydraulic fluid from stationary components of the actuating system 22 such as the hydraulic pump 27 and fluid reservoir 28. In an embodiment where the actuating system is non-hydraulic, the rotary union can carry wire which in turn carries an electrical signal. The rotary union 38 can also carry air if the actuating system is pneumatic. In an embodiment where both contact flanges are movable, the rotary union 38 can carry the “instructions” to both flanges.

Controllable pulley A is in rotational communication with the rotational member. As shown controllable pulley A is mounted directly to the engine crankshaft 19. In another embodiment, controllable pulley A can be mounted to any rotating member being powered by the engine, such as a camshaft (not shown). In yet another embodiment controllable pulley A may be mounted to any non-engine component and rotationally driven by a rotating engine member via a belt, chain or linkage. In an embodiment, the controllable pulley A is driven at a speed equal to the speed of the rotational member 19. In another embodiment the controllable pulley A is driven at a speed directly proportional to the speed of the rotational member 19.

Auto-tensioning Pulley

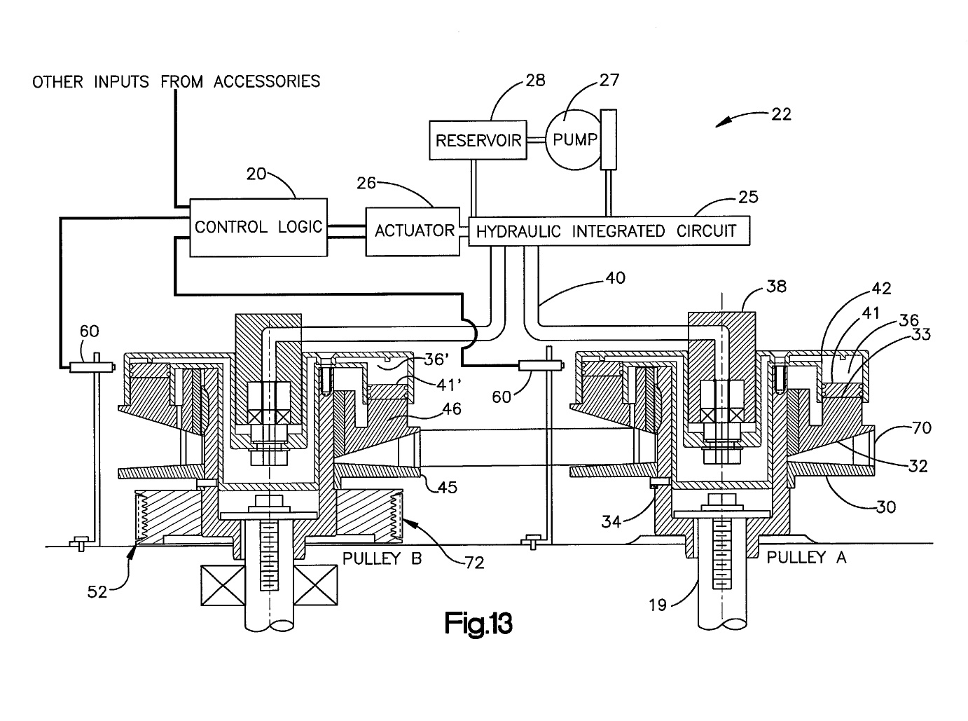

Auto-tensioning pulley B comprises a first contact flange 45 and a second contact flange 46, an auto-tensioning device 48, a mounting shaft 50 and a continuous belt drive sheave 52. One or both of contact flanges 45 and 46 are movable. The position of the belt 70 between the first contact flange 45 and the second contact flange 46 defines the pitch radius of auto-tensioning pulley B. The auto-tensioning pulley B functions to maintain consistent tension within the belt 70. Further, the continuous belt drive sheave 52 of the auto-tensioning pulley B functions to drive one or more accessories 100. In the embodiment shown in FIG. 1, the auto-tensioning device 48 functions to move the movable flange 46 in order to maintain a constant tension within the belt 70. The auto-tensioning device 48 can be a spring 54. The auto-tensioning device 48 can also be a cam and pin system 55 which works in combination with the spring 54. In another embodiment, as shown in FIG. 13, no auto-tensioning device is used because pulley B uses a controllable system similar to that used to actuate controllable pulley A. In this embodiment pulley B includes a piston 41′ and piston housing 36′ or other linear actuating members to actuate the movable flange 46. Referring back to FIG. 1, auto-tensioning pulley B is mounted independently from the rotational member through bearing 56. Auto-tensioning pulley B is supported by bracket 58 and cover 59 and rotates on shaft 50. In another embodiment, auto-tensioning pulley B can be mounted to any accessory, engine component, bracket attached to the rotational member, or any part of a vehicle that is not powered by the rotational member. As shown in FIG. 2, auto-tensioning pulley B functions to drive continuous belt 72 through continuous belt drive sheave 52, which drives all desired accessories 100, which are thus dependent on the speed of pulley B. Continuous belt drive sheave 52 can be attached to auto tensioning pulley B.

Sensing Devices

Referring back to FIG. 1, one or more sensing devices 60 are part of the variable speed drive system 15. The sensing devices 60 function to detect electric pulse, current, magnetic, optical, positional or any other indicators which directly or indirectly measure either pulley flange position, belt speed, pulley A or B revolutions per minute or any accessory speed or requirement. The sensing devices 60 can include Hall Effect switches, Reed switches, Inductive switches, photo-electric switches, laser sensors, eddy current sensors, encoders, linear variable differential transformers, and magnostrictive sensors. The sensing devices can be remote or integral with the pulleys and accessories. The sensing devices 60 are in electrical communication with the control logic module 20 and transmit data to the control logic module 20.

Control Logic

As shown in FIG. 1, a control logic module 20 is part of the variable speed drive system 15. The control logic module 20 accepts input data from various sensing devices 60 and provides signals to one or more actuators 26. Actuators 26 can be solenoids, springs, linkages, etc. For example, if data from the sensing devices 60 reflects that the accessory speed is too slow, or if one or more of the accessories is in a state of under or over capacity and requires being driven at an increased or decreased speed, the control logic module 20 will signal one or more actuators 26 to execute changes, within the actuating system 22, which will in turn change the speed of the accessories 100. In an embodiment, the control logic module 20 is a vehicle's on-board electronic engine control module. In another embodiment the control logic module 20 is a separate device with open loop or closed loop control logic. The control logic module 20 can include, but is not limited to a custom electronic board, wave soldered or surface mount electronic components, engineered and assembled to provide input and out signals necessary for the specific application of the variable speed drive to the user's device. The control logic module 20 can include, but is not limited to an industrial computer or personal computer, laptop or mainframe utilizing data acquisition software such as National Instrument's Labview Software 6I using a programmed virtual instrument. The control logic module can include, but is not limited to a programmable logic controller utilizing standard ladder logic or programmed sequence logic. An example would be: PLC direct DL 105 or DL 205 PLC with ladder or stage programming utilizing AC/DC or digital and analog input/output modules for real world sensor and fluid power solenoid valve connections.

Belts

One or more belts are part of the variable speed drive system 15. Belts function to transmit power and rotational motion from one pulley to another pulley and from pulleys to accessories. One or more belts 70 run between controllable pulley A and auto-tensioning pulley B. In an embodiment where both controllable pulley A and auto-tensioning pulley B have one movable flange on the same side of the pulley system, an asymmetric belt can be used. In an embodiment where both controllable pulley A and auto-tensioning pulley B have one movable flange on opposite sides of the pulley system (not shown), or in an embodiment where both controllable pulley A and auto-tensioning pulley B have two movable flanges, as shown in FIG. 11, a V-belt or any other shape of symmetric belt can be used. A second, continuous belt 72 runs between the belt drive sheave 52 of auto-tensioning pulley B and the accessories 100. Continuous belt 72 can be a grooved belt and can have teeth. As shown in FIG. 2, a single continuous belt 72 can drive numerous accessories 100.

Accessories

As shown in FIG. 2, the variable speed drive system 15 further comprises one or more accessories 100. Accessories are any device that is powered either directly or indirectly by an engine for any purpose other than the direct propulsion of a vehicle. The accessories can include, but are not limited to, alternators 102, generators, power steering pumps 104, air conditioners 106, water pumps 107, cooling fans, or air pumps. The tensioner 108 can be a sheave mounted to a spring-loaded arm. The idler 110 can be a sheave with a center bearing.

C. Actuation

i. Hydraulic

Referring to FIG. 1, in an embodiment, the contact flange 32 of controllable pulley A is actuated hydraulically. As stated above, hydraulic fluid is pumped from the hydraulic pump 27 to the hydraulic chamber 36 through hydraulic fluid supply lines 40. The hydraulic chamber 36 may be open and adjacent to a piston 41. The actuating system 22, when it is a hydraulic type, comprises an actuator 26, a hydraulic integrated circuit 25, a pump 27, hydraulic fluid, the piston 41, piston housing 42, rotary union 38 and a fluid reservoir 28. One or more elements of the actuating system may be located remotely from the controllable pulley A and auto-tensioning pulley B. For example, in an embodiment where the variable speed drive system 15 is part of a vehicle which includes a power steering system, the pump and reservoir of power steering system may also act as the pump 27 and reservoir 28 of the actuating system 22 and the pump and reservoir are located remotely from the pulleys.

The actuating system 22 may be used to actuate a single movable flange on controllable pulley A within an embodiment having only one movable flange on controllable pulley A. In an embodiment wherein controllable pulley A includes two movable flanges, shown in FIG. 12, the actuating system 22 may actuate both flanges. Referring back to FIG. 1, the hydraulic fluid is directed to the controllable pulley A at a controlled rate of flow and a controlled direction from a fluid reservoir 28. Pressure is developed by the pump 27 or by tension within belt 70. The hydraulic integrated circuit 25 acting in conjunction with the control logic module 20 and one or more actuators 26 controls the flow rate and direction of the hydraulic fluid. The actuator(s) 26 itself can be pneumatic, electric, or hydraulic. The hydraulic integrated circuit 25 can comprise any necessary control valves, flow valves, pressure relief valves and orifices. The actuator 26 functions to open and close any control valves, or actuate any other devices, within the hydraulic integrated circuit 25. In an embodiment, the hydraulic integrated circuit can be a single three-way control valve that actuates the movable flange 32 in either direction. In another embodiment, the hydraulic integrated circuit can be two two-way control valves, where one of the two-way control valves operates the movable flange 32 in a particular direction, and the other two-way control valve actuates the movable flange 32 in the opposite direction. In yet another embodiment, the hydraulic integrated circuit can be a four-way control valve which actuates either chamber of a double-acting hydraulic cylinder in order to actuate movable flange 32.

The response time, defined as the time between when a signal from a sensor is received by the control logic to the time when the movable flange is moved to a desired position, can be on the order of ½ second or even faster, for the hydraulic actuating system. The response time attainable for an embodiment using a hydraulic actuating system is dependent on the hydraulic integrated circuitry resistance of the valves, lines, connections etc., as well as the electrical characteristics of the solenoids used to actuate the valves and the sensing device and the control logic module response time. Response time also depends on the load caused by the accessories. Of course, it will be appreciated that much faster response times can be achieved with other designs such as electromechanical linear actuators. In an embodiment of the invention where the corresponding response time for the rotational member to change its speed is faster than the response time for the variable speed drive system, a speed governor may be fitted with the engine or other rotational member system.

Centrifugal Force Hydraulic Fluid Compensating Devices

In an embodiment using hydraulic actuation of the contact flanges 32 on controllable pulley A, performance is increased by compensating for the effect of centrifugal force upon the hydraulic fluid within the piston housing 42. As the fluid is rotated within the controllable pulley A, the fluid is forced against the outside wall of the piston housing 42. Unable to move the outside wall, a portion of the centrifugal force is transferred to the contact flange 32 which can slow the movement of the contact flange 32 when hydraulic fluid is being evacuated from the chamber 36. This effect can slow the recovery motion of the contact flange 32. A similar effect can occur within a rotating hydraulic cylinder.

To compensate for the centrifugal force effect of the rotating hydraulic fluid, embodiments which add to the force created by the belt 70 are used. These devices help move the contact flange at a desired rate during recovery. As shown in FIG. 3, one embodiment utilizes a counterweight system 110. The counterweight system 110 comprises a weight housing 112, a ramp 114, a cable bracket 116, a cable 118 and two or more weights 120. The weight housing 112 has an L-shaped cross section and is attached to the controllable pulley A. The weight housing 112 functions to enclose the weight 120 and support the ramp 114. The ramp 114 acts as a support for the weight 120. The ramp 114 keeps the weight 120 in a preferred position while controllable pulley A is rotating which allows the force exhibited by the weight 120 to be exerted in an optimal direction. The cable bracket 116 joins the cable 118 to the rear face of the contact flange 32. The cable 118 joins the weight 120 to the cable bracket 116 and allows the weight 120 to travel along the ramp 114. The weight 120 functions to generate a force upon the contact flange 32 when the controllable pulley A is rotating which counteracts the centrifugal force of the rotating hydraulic fluid.

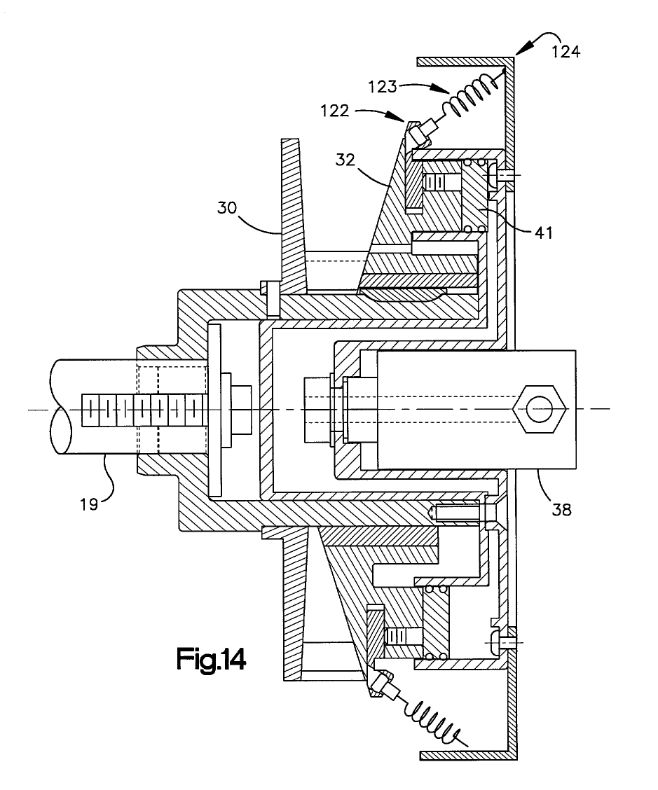

In another embodiment, a spring venting system 121, as shown in FIG. 14, is used to compensate for the centrifugal force effect of the rotating hydraulic fluid. The spring venting system 121 comprises a bracket 122 attached to the contact flange 32, a tension spring 123 and a spring housing 124. The bracket 122 is attached to one end of the tension spring 123 and the spring housing 124 is attached to the alternate end of the tension spring 123. Upon rotation of the controllable pulley A, the tension spring 123 resists slight movements of the contact flange 32.

Non-rotating Hydraulic Fluid Embodiments

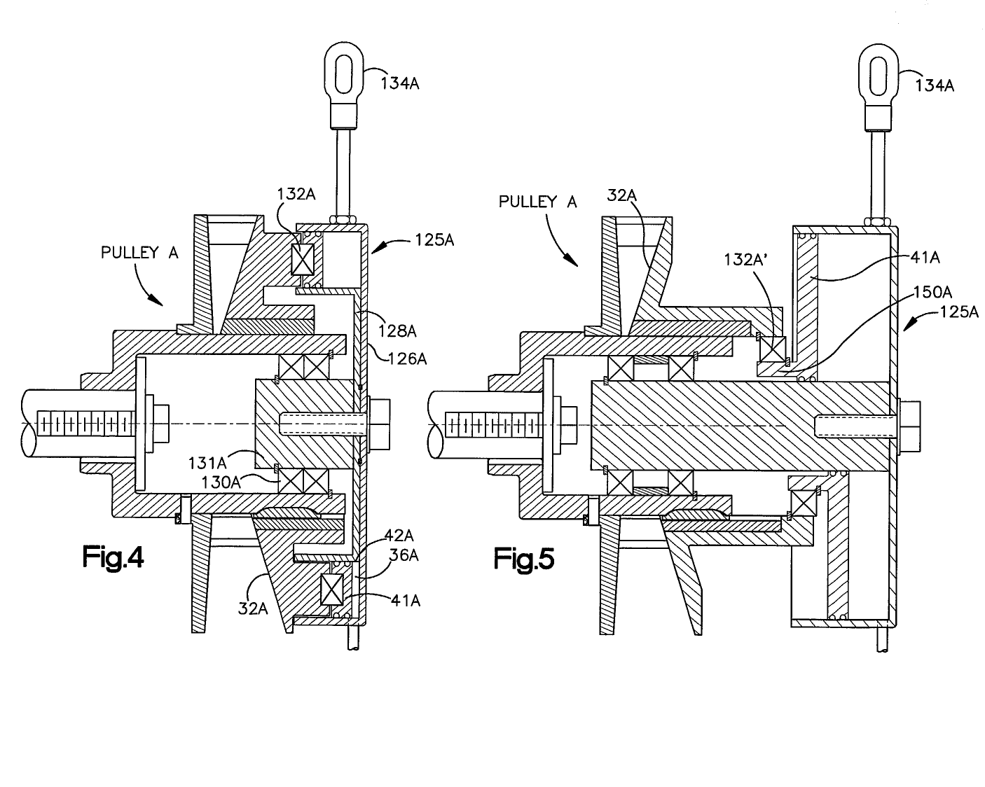

In another embodiment, shown in FIG. 4 and called a non-rotating chamber system 125A, the piston 41A, piston housing 42A, and hydraulic chamber 36A are non-rotating relative to the rotating controllable pulley A. Thus, no centrifugal force is generated within the hydraulic fluid chamber 36A. The non-rotating chamber system 125A is attached to controllable pulley A and comprises an end bracket 126A, interior bracket 128A, central contact bearing 130A, shaft 131A, peripheral contact bearing 132A, and a torque arm 134A as well as the piston 41A, piston housing 42A and hydraulic fluid chamber 36A. The piston 41A can be considered a linear actuating member. The end bracket 126A can be a circular plate with a peripheral flange. The end bracket 126A can be attached to the shaft 131A. The end bracket 126A functions to define the back and exterior side wall of the hydraulic fluid chamber 36A. The interior bracket 128A is a circular plate with a peripheral flange. The interior bracket 128A is attached to the shaft 131A. The peripheral flange of the interior bracket 128A functions to define the interior side wall of the hydraulic fluid chamber. The shaft 131A is coaxial with the mounting shaft 34 of controllable pulley A. The central contact bearing 130A is an angular contact bearing. The central contact bearing is a junction between the non-rotating shaft 131A and the rotating controllable pulley A. The peripheral contact bearing 132A is a thrust bearing. The peripheral contact bearing 132A is a junction between the non-rotating piston 41A and the rotating contact flange 32A. The torque arm 134A is attached to the peripheral flange of the end bracket 126A. The torque arm 134A prevents any rotation of the hydraulic chamber 36A which may be caused by inherent friction within the contact bearings 130A and 132A.

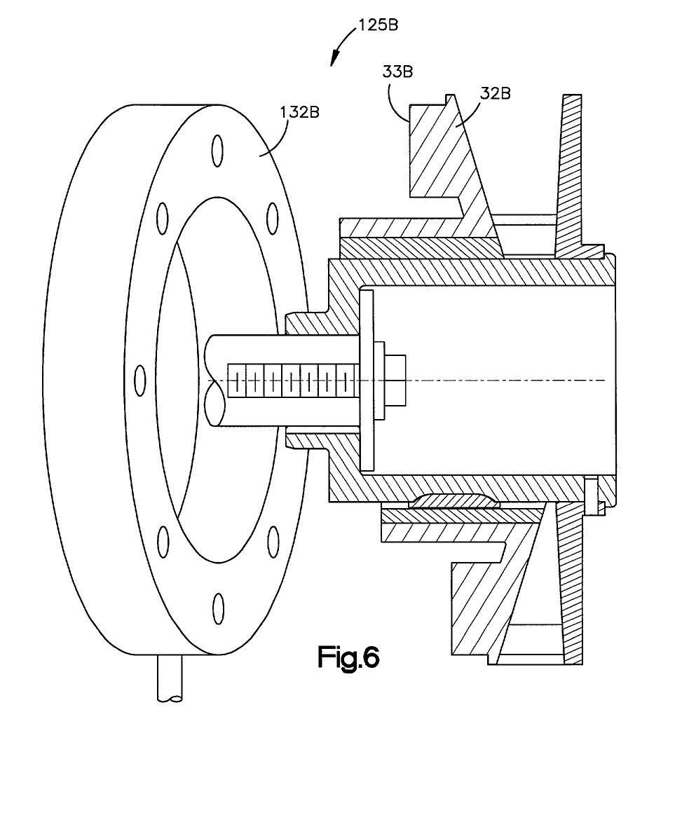

In another form of the non-rotating chamber system 125A, shown in FIG. 5, the piston 41A additionally comprises an interior actuating leg 150A. The interior actuating leg 150A actuates the contact flange 32A through the peripheral contact bearing 132A′. The peripheral contact bearing 132A′ is an angular contact bearing in this form of the non-rotating chamber embodiment.

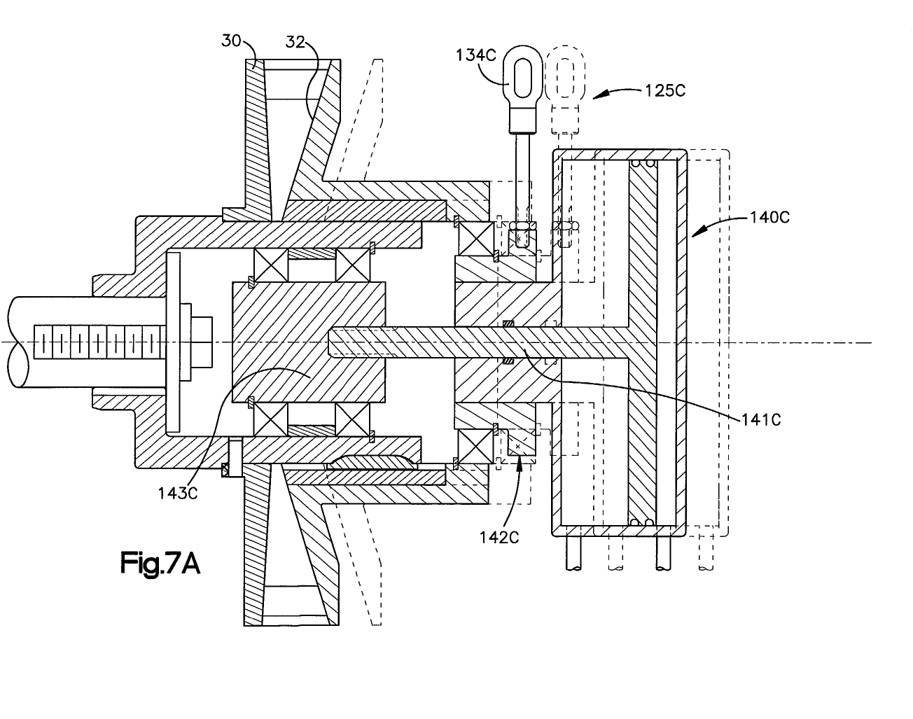

In yet another form of the non-rotating chamber system 125B, shown in FIG. 6, the end bracket 126B, interior bracket 128B, central contact bearing 130B, peripheral contact bearing 132B, torque arm 134B, piston 41B, piston housing 42B and hydraulic fluid chamber 36B are located adjacent to the object to which the controllable pulley A mounts.

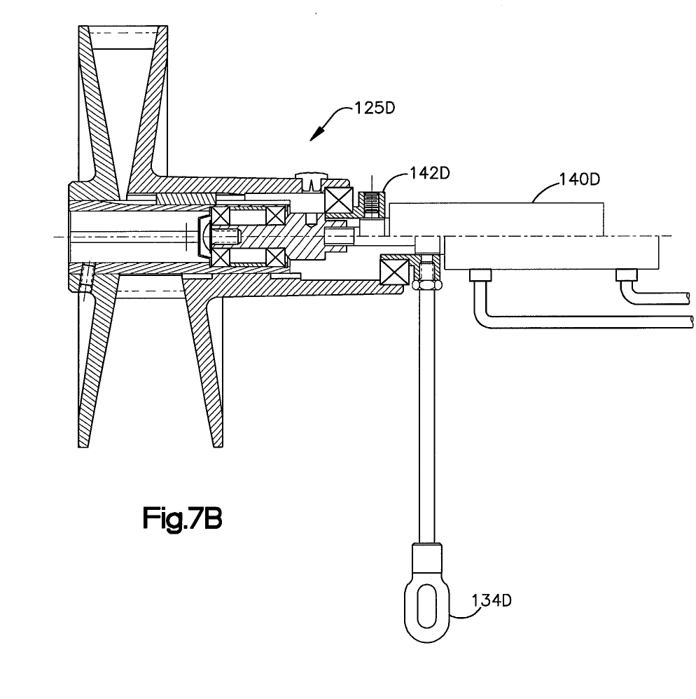

In still yet other forms of the non-rotating chamber system 125C, 125D and 125E, shown in FIGS. 7A, 7B, and 7C, a hydraulic cylinder 140, arm 141, stem 143 and thrust nut 142 are used within the actuating system in place of a hydraulic chamber and piston to move the contact flange. These cylinders can also be pneumatic.

Referring to FIG. 7A, a form of the non-rotating chamber system 125C is shown using a double acting hydraulic cylinder 140C. Within embodiments including a hydraulic cylinder 140, the hydraulic cylinder 140 is a part of the actuating system and is actuated by the other components of the actuating system. The hydraulic cylinder 140C moves an arm 141C when the hydraulic cylinder 140C is actuated. The hydraulic cylinder can be considered a linear actuating member because it provides a force which is in-line and parallel with the direction of movement of the contact flange 32. The hydraulic cylinder 140C is joined to a thrust nut 142C which is rotationally joined to the contact flange 32. The thrust nut 142C functions as a junction between the linearly actuation hydraulic cylinder 140C the rotating contact flange 32. Thus, when the hydraulic cylinder 140C is actuated, motion of the hydraulic cylinder 140C moves contact flange 32. Torque arm 134C functions to restrict thrust nut 142 and hydraulic cylinder 140C from rotating. Referring to FIG. 7B, a form of the non-rotating chamber system 125D is shown using a double acting hydraulic cylinder 140D having a linear configuration and a controllable pulley A designed to accept a V-shaped belt.

Referring to FIG. 7C, a form of the non-rotating chamber system 125E is shown using a remotely located double acting hydraulic cylinder 140E which can be actuated in inward and outward directions. The arm 141E is attached to a first end of a linkage 146E which functions to translate the motion of the arm, which is located away from the contact flange 32, to the contact flange 32. The linkage can be made of any number of rigid links. The linkage 146E can be fixed to any number of stationary points to provide pivot points. A second end of the linkage 146E is attached to the contact flange via a U-joint 148E and an angular contact bearing 144E. The U-joint 148E and angular contact bearing 144E allow the non-linear motion of the linkage to be translated into a linear motion to move the contact flange 32.

Other embodiments of the invention replace the hydraulic cylinder 140 with a pneumatic cylinder. The pneumatic cylinder may be actuated by positive air pressure or vacuum.

ii. Non-hydraulic

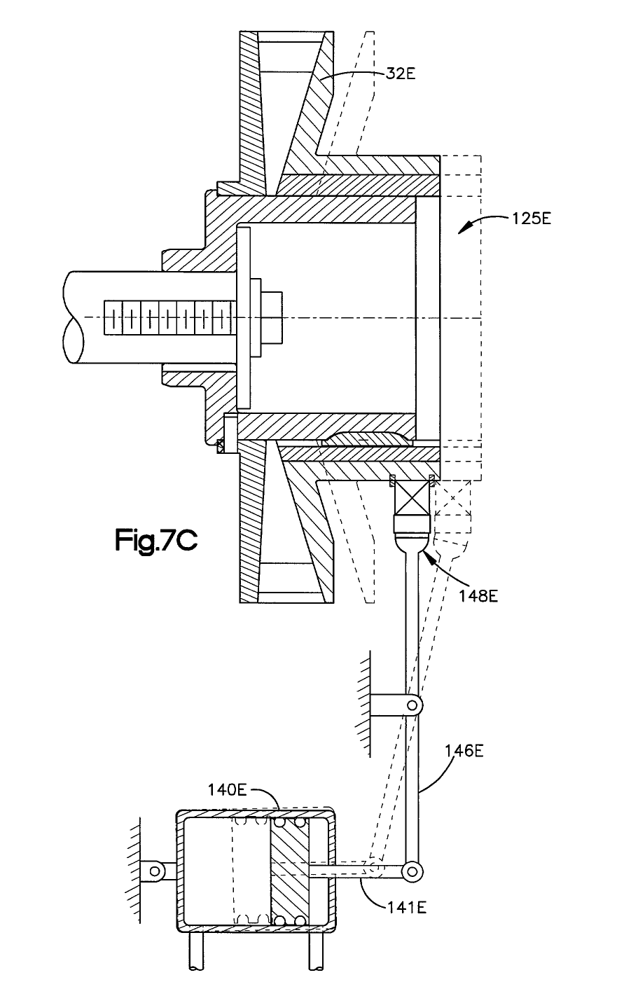

Referring to FIGS. 8-10, other embodiments of the invention are shown where the second or first and second flanges 30 and 32 on the controllable pulley A are actuated in a non-hydraulic manner. Non-hydraulic methods of actuation include spring actuation, pneumatic (as mentioned above) or vacuum pressure actuation, electric motor and gear rotation actuation, thermally responsive material actuation, electromechanical linear actuation and magnetic actuation. Thermally responsive materials expand under heat, such as that supplied via one or more resistive elements exposed to a current, in a controllable, predictable and repeatable manner. Thermally responsive materials can include polymers, metals, and fluids.

FIG. 8 shows an electromechanical linear actuation device 160. Wires 162 carrying an electrical signal cause a linear electric motor 166 mounted to a thrust nut 164 to move the linear electric motor 166 relative to the stationary stem in an inward or outward direction. The thrust nut 164 functions as a junction between the linearly actuation electric motor 166 and the rotating contact flange 32. Angular contact bearings 168 isolate the rotating members from the non-rotating members of the electromechanical linear actuation device 160. The actuation system within this embodiment comprises linear electric motor 166 and thrust nut 164 as well as an AC or DC electric power supply. Movement of the linear electric motor 166 causes movement of the contact flange 32.

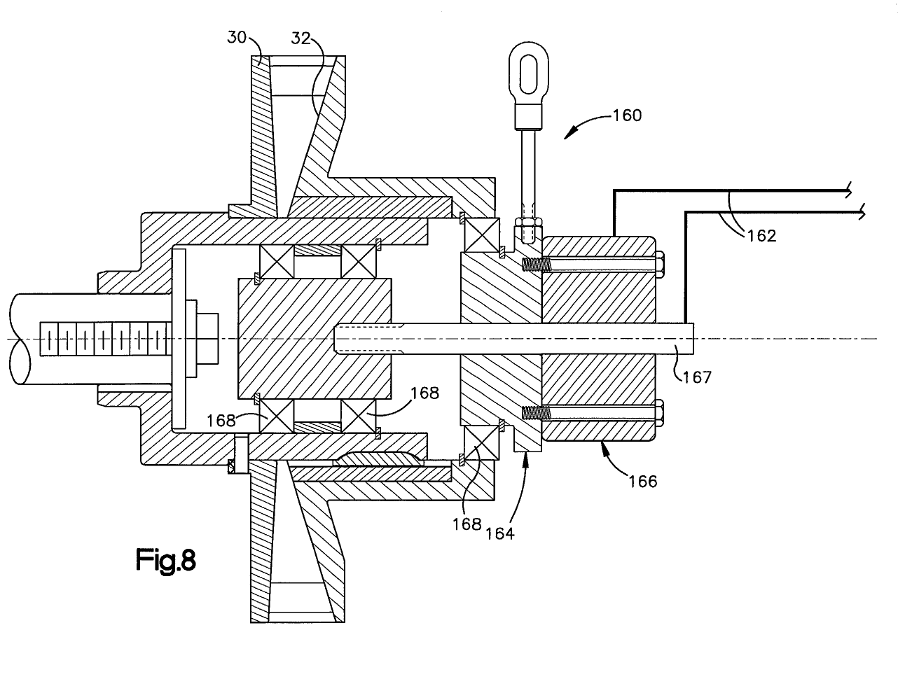

FIG. 9 shows a thermally responsive material 170 used to move a cap 176. The cap 176 acts as a junction between the thermally responsive material 170 and the movable contact flange 32. Wires 172 bring electrical current to one or more resistive elements 174. Electric power applied to the resistive elements 174 cause the elements 174 to heat up. The resistive elements 174 can be embedded within the material 170. Application of heat to the material 170 causes expansion, while removal of heat causes retraction.

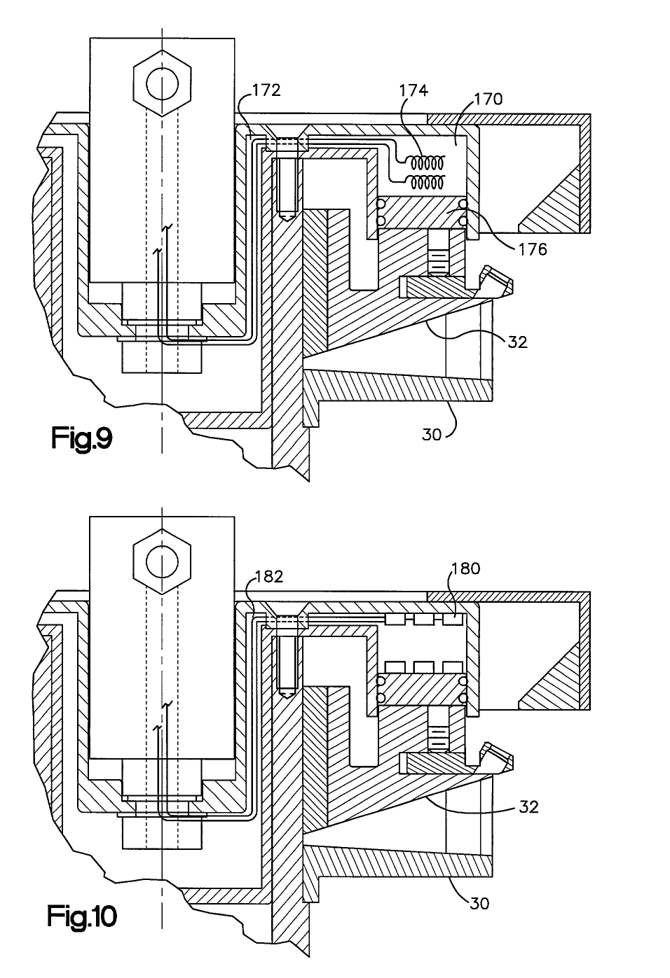

FIG. 10 shows one or more magnets 180, or magnetic actuators, used to move contact flange 32. Wires 182 can be used to activate one or more magnets 180 if they are electromagnets. Magnets 180 can be located on rear face 33 of the contact flange 32, the chamber 36 or both. Magnets 180 which are not electromagnets may be permanent magnets.

iii. Recovery

Referring back to FIG. 1, the variable speed drive system 15 is infinitely adjustable between maximum overdrive and underdrive conditions and maximum and minimum pitch ratios. Therefore, after the controllable pulley A and auto-tensioning pulley B are actuated to increase or decrease accessory speed, the pulleys can be actuated to achieve an opposite or desired variation in speed. In an embodiment utilizing hydraulic actuation, the contact flange 32 of controllable pulley A can be moved in an opposite direction by releasing hydraulic pressure. Pressure release is achieved by the control logic module 20 and actuating system 22. Evacuation of hydraulic fluid will occur when the actuator 26 opens the appropriate control valve within the hydraulic integrated circuit 25. Movement of the contact flange 32 may be assisted by a spring, vacuum force, linear electric force or centrifugal force generated by rotating weights. In an embodiment including a two-way actuable hydraulic cylinder, movement of the contact flange 32 is achieved by forcing fluid into the second chamber of the cylinder.

iv. Pulley Variation

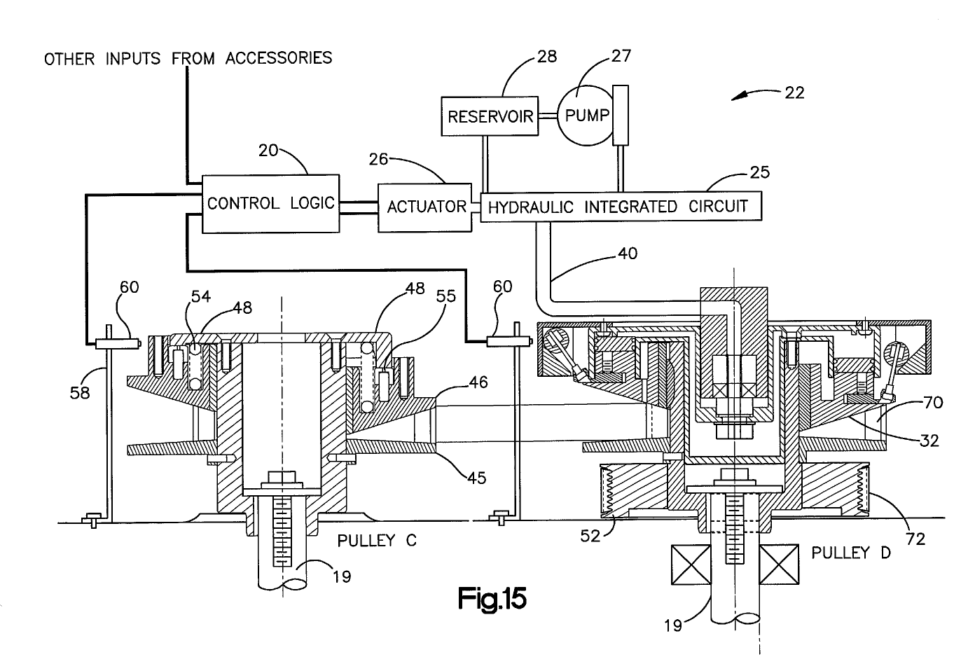

It is readily apparent to one skilled in the art that in an embodiment, as shown in FIG. 15, a rotational member 19 can be in rotational communication with an auto-tensioning pulley C. In this embodiment, the auto-tensioning pulley C can then drive a controllable pulley D via a belt 70. The controllable pulley D, including a movable contact flange 32 actuated by an actuating system 22, can drive one or more accessories via a continuous belt drive sheave 52 and a second belt 72.

II. Operation

a. General

The variable speed drive system 15, as exemplified in FIG. 1, acts to vary the speed of the rotational motion translated from a rotational member such as an internal combustion engine in a truck, car, or construction or farm machinery to one or more accessories 100. The controllable pulley A, attached directly to or driven by the rotational member, rotates at a speed equivalent to or directly proportional to the rotational member speed. As the rotational member speed increases or decreases, or as the load on the accessories increases or decreases, the speed of the accessories 100 can be changed accordingly. These changes of accessory speed can be independent of the changes in rotational member speed.

b. Sensing

A sensing device 60 senses a system measurement, such as electric pulse, current, magnetic, optical, or positional indicators. These indicators can reveal system performance or accessory requirements through such measurements as pulley flange position, belt speed, pulley revolutions per minute, or accessory speed as examples. Of course, it will be appreciated that these are just exemplary and the measurements and indicators could be used for sensing system status to determine requirements. Data from the sensing devices 60 is transferred to the control logic module 20. Data from the sensing devices indirectly controls the speed of the auto-tensioning pulley independently from the speed of the rotational member. For example, a sensing device may sense an increased electrical load upon the alternator of a vehicle and as a result, indirectly through the control logic module, actuators, etc., increase the speed of the auto-tensioning pulley to satisfy the increased electrical load. This increase can be made with no speed change within the rotational member.

c. Logic

The control logic module 20, using data from the sensing devices 60, determines whether pulley B is driving the accessories too fast or too slow, or if one or more of the accessories 100 is in a state of under or overload and requires being driven at an increased or decreased speed. Once the control logic module 20 determines that one or more accessories 100 need to be driven at a changed speed, the control logic module 29 signals the actuating system 22 to move the flange(s) within controllable pulley A. In an embodiment where pulley B is controllable the actuating system or a second actuating system moves the flanges within controllable pulley B as well.

The control logic module 20 can increase accessory speed as desired, independently of actual rotational member speed, based instead on input from any or all sensors 60 of all types, located anywhere on the vehicle.

d. Actuation

Hydraulic

In an embodiment using a hydraulic actuating system 22 without a double acting cylinder, the actuating system 22 directs hydraulic fluid to the controllable pulley A. The actuator 26 opens one or more control valves within the hydraulic integrated circuit 25. The hydraulic integrated circuit 25 receives hydraulic fluid and pressure from the fluid pump 27 and directs the pressurized hydraulic fluid through a flexible or rigid conduit 40 to the rotary union 38. In an embodiment of the invention, the fluid pump 27 can be the power steering pump of a vehicle. The rotary union 38 directs the hydraulic fluid into the hydraulic chamber 36 of the controllable pulley A. In an embodiment where controllable pulley A has one movable flange 32, the hydraulic fluid actuates the flange. Actuation occurs when the hydraulic fluid fills the hydraulic chamber 36, within the piston housing 42, and pushes against the piston 41. The movement of the piston 41 moves the contact flange 32. In an embodiment where controllable pulley A has two movable flanges, the hydraulic fluid can enter both hydraulic chambers 36 and 39. In an embodiment having two movable flanges, but only a single hydraulic chamber 36, a mechanical linkage between the contact flanges 30 and 32 allows equal relative movement either together or apart.

In an embodiment including a double acting hydraulic cylinder 140, fluid is directed to the cylinder and actuation of the cylinder moves the contact flange 32. Within an embodiment where the hydraulic fluid rotates with controllable pulley A, a centrifugal force hydraulic fluid compensating device can compensate for the force applied against contact flange 32 generated by the rotating hydraulic fluid. In an embodiment where both controllable pulley A and auto-tensioning pulley B have movable flanges which are hydraulically actuated, the degree of relative actuation between each pulley is governed by the hydraulic pressure differential between the pulleys or by the use of a four-way control valve within the hydraulic integrated circuit 25.

Non-hydraulic

In one embodiment of the invention, the double acting cylinder is instead actuated by positive air pressure or vacuum. In another embodiment, shown in FIG. 8, an electromechanical linear actuation device 160 moves the contact flange 32. An electrical signal is sent from the control logic module 20 or an AC or DC power source through wires 162 to the linear electric motor 166 which in turn moves the contact flange 32 either outward or inward. In yet another embodiment, shown in FIG. 9, the electrical signal can be sent from the control logic module 20 or AC or DC power source to one or more resistive elements 174 embedded within a thermally responsive material 170. In response to the heat generated by the resistive elements 174, the thermally responsive material 170 expands and moves the cap 176 and contact flange 32. When the electrical signal is stopped, the thermally responsive material 170 cools, allowing the cap 176 and contact flange 32 to retract. In still yet another embodiment, shown in FIG. 10, the electrical signal can be sent to one or more magnets 180. A repulsive magnetic force is generated which moves one set of magnets 180 away from the other magnets 180 or simply the contact flange 32, thus, moving the contact flange 32.

It will be appreciated by those of skill in the art that in any embodiment including more than one movable flange, combinations of hydraulic and non-hydraulic devices or differing types of hydraulic devices can be used to move the flanges.

e. Shift

The actuation of the contact flange or flanges 30 and 32 of the controllable pulley A causes the pitch radius of controllable pulley A to change. The pitch radius of the auto-tensioning pulley B responds in the opposite manner, and in such a way as to automatically maintain proper tension on belt 70. The pitch ratio is the pitch radius of control pulley A divided by the pitch radius of auto-tensioning pulley B. The speed of the auto-tensioning pulley B is equal to the pitch ratio multiplied by the speed on the controllable pulley A. The pitch radius of the controllable pulley A is at maximum when the outside of the belt 70 is even with the outside of the controllable pulley contact flanges 30 and 32. In this condition, the pitch radius of the auto-tensioning pulley B is at a minimum, and the variable speed drive system 15 is at the largest possible pitch ratio, which is known as the maximum over-drive condition. The pitch radius of the auto-tensioning pulley B is at maximum when the outside of the belt 70 is even with the outside of the auto-tensioning pulley contact flanges 45 and 46. In this condition, the pitch radius of controllable pulley A is at minimum, and the variable speed drive system 15 is at the smallest possible pitch ratio, which is known as the maximum under-drive condition.

The variable speed drive system 15 has certain maximum over-drive and under-drive conditions. Between these conditions the drive system 15 is infinitely variable, meaning that all possible pitch ratios can be achieved. The drive system 15 is infinitely variable at any and all expected rotational member operating speeds above zero. The speed of the drive system 15 is defined as the speed of the auto-tensioning pulley B. In an embodiment where controllable pulley A is driven at a speed equal to the rotational member speed, the maximum drive system operating speed is the maximum rotational member speed times the smallest possible pitch ratio. Similarly, the minimum drive system operating speed is the minimum rotational member speed times the largest possible pitch ratio. In an embodiment where controllable pulley A is driven at a speed directly proportional to the rotational member speed, the ratio of these speeds times the rotational member speed and minimum or maximum pitch ratio defines the minimum and maximum operating speeds of the drive system respectively.

The pitch ratio of the variable speed drive system can vary independently of the rotational member speed. In an example clearly illustrating the independence of the variable speed drive system, the speed of the rotational member can be increasing while the pitch ratio of the variable speed drive system is decreasing. Such a situation can occur when the load within an accessory such as the alternator of a vehicle is decreased, for example by turning off the headlights on the vehicle, at a time when the rotational member speed is accelerating. Although the rotational member speed is increasing, the variable speed drive system adjusts pitch ratios to decrease the speed of the auto-tensioning pulley and, thus, the alternator speed thereby reducing wear on the accessories.

f. Compensation of Auto-tensioning Pulley

Actuation of one or both contact flanges 30 and 32 of controllable pulley A can change the pitch radius of controllable pulley A. Once the belt 70 within controllable pulley A has changed position due to the change of pitch radius, the auto-tensioning pulley B responds by changing its effective pitch radius while maintaining proper variable speed belt tension required to transmit the required power from controllable pulley A to auto-tensioning pulley B to drive the engine accessories. Controlled belt tension is maintained by the auto-tensioning device 48 of auto-tensioning pulley B.

g. Accessory Driving

Auto-tensioning pulley B drives continuous belt 72, shown in FIG. 2, through continuous belt drive sheave 52, which drives all desired accessories 100, which are thus dependent on the speed of auto-tensioning pulley B. Tensioner 108 keeps the tension within the belt within a preferred range. One or more idlers 110 keep the belt within a preferred orientation.

h. Steady State

When all or selected accessories 100 are operating at a level of performance accepted by control logic module 20, stabilization of the speed of the auto-tensioning pulley B is maintained by control logic module 20 until conditions change. These condition include, but are not limited to, changes in rotational member speed or increase or decrease of accessory load.

i. Recovery

The system may also recover, or change speed in a contrasting manner as compared to an initial change. As with the initial action, recovery is initiated by information obtained by the sensing devices 60. Recovery is necessitated by a change in rotational member speed or a change in the load on the accessories. The sensing devices 60 send signals to the control logic module 20. The control logic module 20 actuates the actuator 26 within the actuating system 22.

In an embodiment using hydraulic actuation with two two-way control valves as the hydraulic integrated circuit 25, the control logic module 20 would act upon actuator 26, which opens the appropriate two-way valve, releasing hydraulic pressure on piston 41, allowing hydraulic fluid to flow from hydraulic chamber 36, back through rotary union 38, through fluid supply lines 40, and returning through the two-way control valve within the hydraulic integrated circuit 25, effectively returning to reservoir 28. This releases pressure imposed on contact flange 32. The belt tension provides the force required to move the contact flange 32 away from flange 30. This belt force may be added to by spring force, vacuum force, linear electric force or the centrifugal force created by rotating weights.

In an embodiment using a double acting hydraulic cylinder 140, the control logic module would act upon actuator 26 and hydraulic integrated circuit 25, redirecting the flow of hydraulic fluid from the pump 27 into the second chamber of the hydraulic cylinder 37, while simultaneously redirecting the hydraulic fluid from the first chamber of the hydraulic cylinder 140 into the reservoir 28. In other embodiments, this removal of force from contact flange 32 could be accomplished by the removal of spring force, pneumatic pressure, or vacuum pressure. Removal of force can also be accomplished by sending an electrical signal to the linear actuation device 160, or magnets 180, or the removal of the electrical signal from the thermally responsive materials 170, in the respective embodiments, or any other way of releasing the applied force, as discussed above in applying the force.

Once the force is released from contact flange 32 thereby allowing contact flange 32 to travel away from contact flange 30, auto-tensioning pulley B reacts through spring force (or by spring force with torque sensing cam actuation, hydraulic pressure, pneumatic pressure, or vacuum pressure, electric motor and gear rotation, thermo polymer actuation, magnetic, or any other means of generating force, by forcing contact flange 45 automatically) toward contact flange 46. This action increases the driven pitch radius of auto-tensioning pulley B and reduces the driving pitch radius of controllable pulley A. Once the desired accessory speed is achieved, as determined from the sensors on the vehicle and control logic module, the entire system is stabilized until conditions warrant further change.

Additional advantages and modifications will readily appear to those skilled in the art. For example different ways of sensing pulley speed or position may be utilized. Further, different types of control logic may be utilized. Therefore, the invention, in its broader aspects, is not limited to the specific details, the representative apparatus, and illustrative examples shown and described. Accordingly, departures may be made from such details without departing from the spirit or scope of the applicant's general inventive concept.

1. A variable speed drive system for driving accessories comprising:
a rotational member;
a controllable pulley in rotational communication with said rotational member, said controllable pulley including a first movable flange and a corresponding adjustable pitch radius;
an auto-tensioning pulley driven by said controllable pulley via a first belt, said auto-tensioning pulley for maintaining tension in said first belt and said auto tensioning pulley having an operating speed which is infinitely variable between a minimum pitch ratio and a maximum pitch ratio;
an actuating system for moving said first movable flange; and
one or more accessories which are driven by said auto-tensioning pulley via a second belt.

2. The variable speed drive system of claim 1 wherein the actuating system comprises a linear actuating member which generates a force in-line and parallel with the direction of movement of the first movable flange.

3. The variable speed drive system of claim 1 wherein said actuating system is a hydraulic system comprising a hydraulic pump, a control valve, a source of hydraulic fluid, and a hydraulically operated piston connected to said movable flange.

4. The variable speed drive system of claim 3 further comprising a control logic module for receiving data from one or more sensing devices and for signaling the actuating system.

5. The variable speed drive system of claim 3 wherein said actuating system further comprises a hydraulic reservoir and wherein the hydraulic reservoir and hydraulic pump are located remotely from said controllable pulley.

6. The variable speed drive system of claim 1 further comprising a control logic module for receiving data from one or more sensing devices and for signaling the actuating system.

7. The variable speed drive system of claim 1 wherein said controllable pulley further comprises a second movable flange.

8. The variable speed drive system of claim 1 wherein said auto-tensioning pulley includes an auto-tensioning device which is a spring.

9. A vehicle comprising the variable speed drive system of claim 1.

10. The variable speed drive system of claim 1 further including a vehicle wherein said variable speed drive system is mounted in said vehicle.

11. The variable speed drive system of claim 1 further including a counterweight system for partially countering the effect of rotating hydraulic fluid comprising a cable bracket, a cable, and a weight.

12. The variable speed drive system of claim 1 further including a spring venting system for partially countering the effect of rotating hydraulic fluid comprising a spring, a bracket, and a spring housing.

13. The variable speed drive system of claim 1 wherein said rotational member is an engine.

14. A variable speed drive system for driving engine accessories comprising:
an engine;
a first controllable pulley in rotational communication with said engine, said first controllable pulley including a first movable flange and a corresponding adjustable pitch radius;
a second controllable pulley driven by said first controllable pulley via a first belt, said second controllable pulley having a second movable flange, and an operating speed which is infinitely variable between a minimum pitch ratio and a maximum pitch ratio;
an actuating system for moving said first movable flange; and
a belt driving sheave attached to said second controllable pulley which drives one or more accessories via a second belt.

15. The variable speed drive system of claim 14 wherein at least one of said first and second controllable pulleys further comprises an additional movable flange.

16. The variable speed drive system of claim 14 further comprising a control logic module for receiving data from one or more sensing devices and for signaling the actuating system.

17. A variable speed drive system for driving accessories comprising:
a rotational member;
an auto-tensioning pulley in rotational communication with said rotational member, said auto-tensioning pulley for maintaining tension in a first belt;
a controllable pulley driven by said auto-tensioning pulley via said first belt, said controllable pulley including a first movable flange and a corresponding adjustable pitch radius, and said controllable pulley having an operating speed which is infinitely variable between a minimum pitch ratio and a maximum pitch ratio;
an actuating system for moving said first movable flange; and
one or more accessories which are driven by said controllable pulley via a second belt.

18. A vehicle comprising:
an engine;
a first controllable pulley in rotational communication with said engine, said first controllable pulley driving a first belt and including a first movable flange and a corresponding adjustable pitch radius;
an actuating system for moving said first movable flange;
one or more accessories which are driven by a second belt; and
rotating means, said rotating means rotatably connected to said first and second belts, said rotating means having an operating speed which is infinitely variable between a minimum pitch ratio and a maximum pitch ratio.

19. The vehicle of claim 18 wherein said rotating means comprise an auto-tensioning pulley having a spring-biased movable flange, said auto-tensioning pulley having an operating speed which is infinitely variable between a minimum pitch ratio and a maximum pitch ratio.

20. The vehicle of claim 18 wherein said rotating means comprise a second controllable pulley having an operating speed which is infinitely variable between a minimum pitch ratio and a maximum pitch ratio.

21. The vehicle of claim 18 wherein the actuating system comprises a linear actuating member which generates a force in-line and parallel with the direction of movement of the first movable flange.

22. The vehicle of claim 18 further comprising a control logic module for receiving data from one or more sensing devices and for signaling the actuating system.

23. The vehicle of claim 22 wherein said control logic module is an on-board electronic engine control module of the vehicle.

24. The vehicle of claim 18 wherein said vehicle includes a power steering pump and a power steering fluid reservoir, wherein said actuating system comprises said power steering pump, and said power steering fluid reservoir.

25. The vehicle of claim 18 wherein said actuating system comprises an electromechanical linear actuation device.

26. The vehicle of claim 18 wherein said actuating system comprises a thermally responsive material.

27. The vehicle of claim 18 wherein said actuating system comprises one or more magnets.

28. The vehicle of claim 18 further comprising a non-rotating chamber system.

29. A vehicle comprising:
an engine;
one or more engine-driven accessories;
means for driving said accessories wherein said means are independent of engine operating speed and infinitely adjustable between a first minimum underdrive condition and a second maximum overdrive condition.

30. The vehicle of claim 29 wherein said means are remotely controllable.
